(19) United States
(12) Patent Application Publication
(10) Pub. No.: US 2002/0199041 A1
(43) Pub. Date: Dec. 26, 2002

(54) Data storage with scrambling by crossing parallel bit bus

(75) Inventor: Hitoshi Koseki, Hamamatsu-shi (JP)

Correspondence Address: Roger R. Wise, Pillsbury Winthrop LLP, Suite 1200, 725 South Figueroa Street, Los Angeles, CA, 90017-5443, US

(73) Assignee: Yamaha Corporation, Hamamatsu-shi (JP)

(21) Appl. No.: 10/174,649

(22) Filed: Jun. 19, 2002

(30) Foreign Application Priority Data
Jun. 21, 2001 (JP) 2001-188525

(51) Int. Cl. G06F 3/00

(52) U.S. Cl. 710/36

(57) ABSTRACT

An electronic apparatus has a processor for processing data, a storage device for storing the data, a controller for controlling the storage device and a data bus. The storage device stores data represented by a set of bits arranged in an order. The controller reads the data from the storage device and writes the data into the storage device during the course of the processing of the data by the processor. The bus connects between the storage device and the controller for transferring of the data therebetween. The bus is structured by a set of paths enabling parallel transferring of the set of the bits. The set of the paths are disarranged between the controller and the storage device such that the order of the bits of the stored set is changed from the order of the bits of the processed set.

### BACKGROUND OF THE INVENTION

1. Technical Field of the Invention

The present invention relates to an electronic apparatus including a data storage device suitable for storing data or the like such as video data or music data which must be protected from free copying.

2. Prior Art

In recent years, increase in capacity of storage devices such as a hard disk drive is significant. Hard disk drives having huge capacities for storing a volume of multimedia contents data such as music and video are commercially available, and AV (Audio/Visual) apparatus with such a built-in hard disk drive are also developed.

In such an AV apparatus, digital contents data of music or video acquired by legitimate purchase or the like can be stored in a built-in hard disk drive. Further, when reproducing the music or video in accordance with an instruction or the like from a user, a specific item of the contents data can be read from the hard disk drive, and processing of reproducing the music or video can be performed based on the read data.

Meanwhile, in case of storing contents data in a hard disk drive included in the above-described AV apparatus, the contents data stored in the hard disk drive may be possibly illegally copied by various techniques. For example, the hard disk drive having the contents data stored therein is first removed from the AV apparatus. In this technique, then, the contents data stored in the hard disk drive is read by connecting the hard disk drive to a personal computer or the like, and the read data is copied to another medium of the storage device or the like.

As a technique for restricting or preventing illegal copy such as an operation of removing the hard disk drive, there can be considered encryption when recording the contents data in the hard disk drive of the AV apparatus, or use of a special file system (for example, a file system other than general-purpose file systems such as FAT: File Allocation Table or NTFS: NT File System) which manages files in the hard disk drive.

The technique of encrypting and recording the contents data, however, leads to complication of the device structure requiring a configuration of hardware or software for encrypting in case of writing the contents data and decrypting in case of reading) the contents data. Further, the performance of the AV apparatus such as a speed of recording or reading the contents data is deteriorated since encryption and decryption processing time is required additionally.

Furthermore, in case of managing files in the hard disk drive by using a special file system without using a general-purpose file system, the special file system must be newly developed. Moreover, when a special file system is used, a general-purpose file system cannot be used to manage the hard disk drive.

### SUMMARY OF THE INVENTION

In view of the above-described drawbacks of the prior art, it is an object of the present invention to provide an electronic apparatus which does not bring reduction in a recording speed and a reading speed of a data storage device even though the storage has a simple structure, and can suppress illegal copy of data stored in the data storage device even when the data is managed by using a general-purpose file system.

In order to achieve the above object, according to the present invention there is provided an electronic apparatus having a processor for processing data, which comprises a storage device that stores data arranged in a given order, a controller that reads the data from the storage device and writes the data into the storage device during the course of the processing of the data by the processor, and a bus that comprises a set of paths and connects between the storage device and the controller for transferring of the data therebetween through the set of the paths, wherein the set of the paths are disarranged between the controller and the storage device such that the order of the stored data is changed from the order of the processed data.

Practically, the storage device stores the data represented by a set of bits arranged in the given order, the bus comprised of the set of the paths enables parallel transferring of the set of the bits, and the set of the paths are disarranged between the controller and the storage device such that the order of the bits of the stored set is changed from the order of the bits of the processed set.

Typically, the storage device stores the data representative of multimedia contents containing at least one of pictures and music.

According to this structure, when transmitting and recording given data from the controller to the data storage device, this data is supplied and recorded in the data storage device through the bus with a bit order is different from that of the bit set of the original data. Therefore, when the data storage device is removed from this electronic apparatus and connected to another apparatus and data recorded in this data storage device is read, that data cannot be utilized because the bit set is different from the original data, thereby preventing illegal copy. Since illegal copy can be suppressed by the wire connection structure of the bus in this manner, it is not necessary to apply any encryption processing to the data to be recorded, thus suppressing delay or the like of a processing time required for encryption. In addition, in order to suppress the above-described illegal copy, it is not necessary to adopt any special file system for managing data on the data storage device, and a general-purpose file system can be used.

Further, according to another aspect of the present invention, there is provided an electronic apparatus having a processor for processing data, which comprises a storage device that stores data arranged in a given order, a controller that reads the data from the storage device and writes the data into the storage device during the course of the processing of the data by the processor, a bus that comprises a set of paths and connects between the storage device and the controller for transferring of the data therebetween through the set of the paths, and a switching circuit disposed in the middle of the bus for switching the set of the paths according to a given switching pattern such that the order of the data is altered between the stored data and the processed data in correspondence to the switching pattern.

Practically, the storage device stores the data represented by a set of bits arranged in the given order, the bus comprised of the set of the paths enables parallel transferring of the set of the bits, and the switching circuit switches the set of the paths according to a given switching pattern such that the order of the bits is altered between the set stored in the storage device and the set processed by the processor in correspondence to the switching pattern.

Preferably, the switching circuit operates during the course of writing blocks of the data into the storage device for switching the paths according to different switching patterns in correspondence to the respective blocks of the data, and the switching circuit operates during the course of reading one of the blocks of the data from the storage device for switching the paths according to one of the different switching patterns corresponding to said one block of the data to be read. In such a case, the electronic apparatus further comprises a memory for memorizing the correspondence between the different switching patterns and the respective blocks of the data written into the storage device, and a pattern selector for selecting the corresponding one of the different switching patterns by referring to the memory such that the switching circuit can switch the paths according to the selected switching pattern.

According to this inventive structure, in case of transmitting and recording given data from the controller to the data storage device, this data is supplied and recorded to the data storage device through the connection switching circuit and the bus, such that the bit set of the data is different from the original bit set of the data. Therefore, even if the data storage device is removed from this electronic apparatus and connected to another apparatus and the data recorded in this data storage device is read, that data cannot be utilized as the original data, thereby suppressing illegal copy or the like. Stated otherwise, when storing or writing back the data to the storage device, each set of the bits are scrambled through the connection switching circuit by disarranging, crossing, twisting or staggering the bit paths of the data bus according to variable switching pattern. Since illegal copy can be suppressed by the switching pattern of the wires or paths adopted by the connection switching circuit, any encryption processing does not have to be applied to data to be recorded, thus suppressing delay or the like of a processing time required for encryption. Further, in order to suppress the above-described illegal copy, a special file system does not have to be used to manage data on the data storage device, and a general-purpose file system can be used.

### BRIEF DESCRIPTION OF THE DRAWINGS

FIG. 1 is a block diagram showing a structure of an audio apparatus according to a first embodiment of the present invention.

FIG. 2 is a view typically showing a set of paths of a data bus when transmitting data between a CPU, an HDD controller and a hard disk drive in the audio apparatus.

FIG. 3 is a view for illustrating an order of a bit set of data recorded in the hard disk drive.

FIG. 4 is a view typically showing a set of paths of a data bus structure when transmitting data between a CPU, an HDD controller and a hard disk drive in a conventional general electronic apparatus.

FIG. 5 is a view for illustrating the order of a bit set of data recorded in the hard disk drive in the conventional general electronic apparatus.

FIG. 6 is a view typically showing a set of paths of a data bus structure when transmitting data between the hard disk drive removed from the audio apparatus, a CPU and an HDD controller of another apparatus.

FIG. 7 is a view typically showing a set of paths of a data bus structure when transmitting data between the CPU, the HDD controller and the hard disk drive in a modification of the audio apparatus.

FIG. 8 is a view typically showing a set of paths of a data bus structure when transmitting data between the CPU, the HDD controller and the hard disk drive in another modification of the audio apparatus.

FIG. 9 is a block diagram showing a structure of an audio apparatus according to a second embodiment of the present invention.

FIG. 10 is a view typically showing a set of paths of a data bus structure when transmitting data between a CPU, an HDD controller and a hard disk drive in the audio apparatus according to the second embodiment.

FIG. 11 is a view for illustrating switching patterns stored in a ROM in a modification of the audio apparatus according to the second embodiment.

FIG. 12 is a view typically showing a set of paths of a data bus structure when transmitting data between the CPU, the HDD controller and the hard disk drive in another modification of the second embodiment.

FIG. 13 is a view typically showing a set of paths of a data bus structure when transmitting data between the CPU, the HDD controller and the hard disk drive in still another modification of the second embodiment.

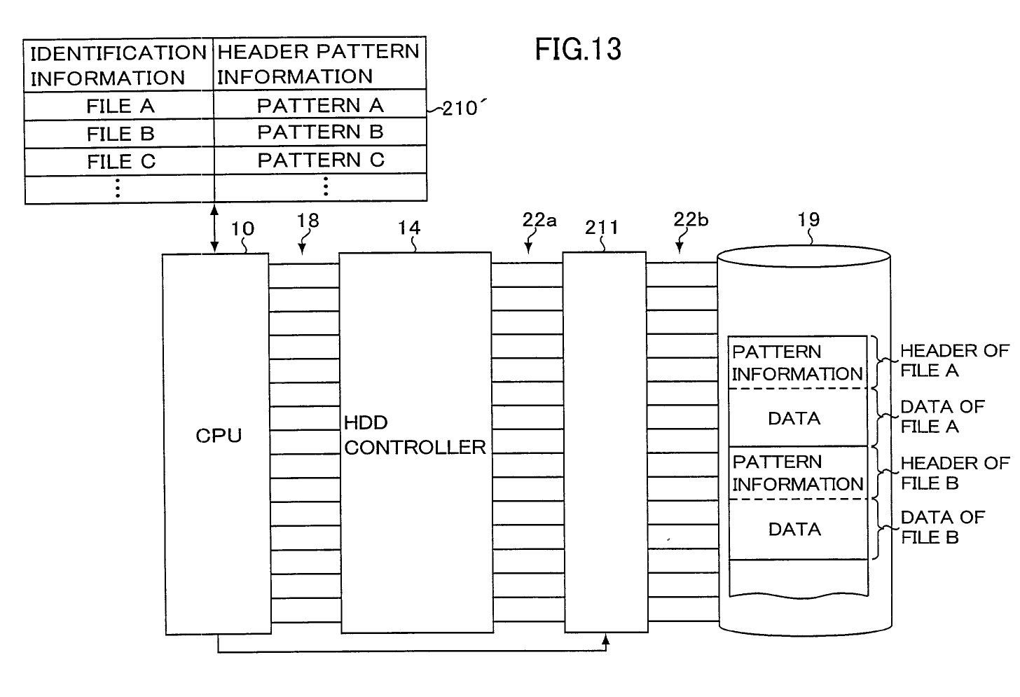

### DETAILED DESCRIPTION OF THE EMBODIMENTS

Embodiments according to the present invention will now be described hereinafter with reference to the accompanying drawings.

A. First Embodiment

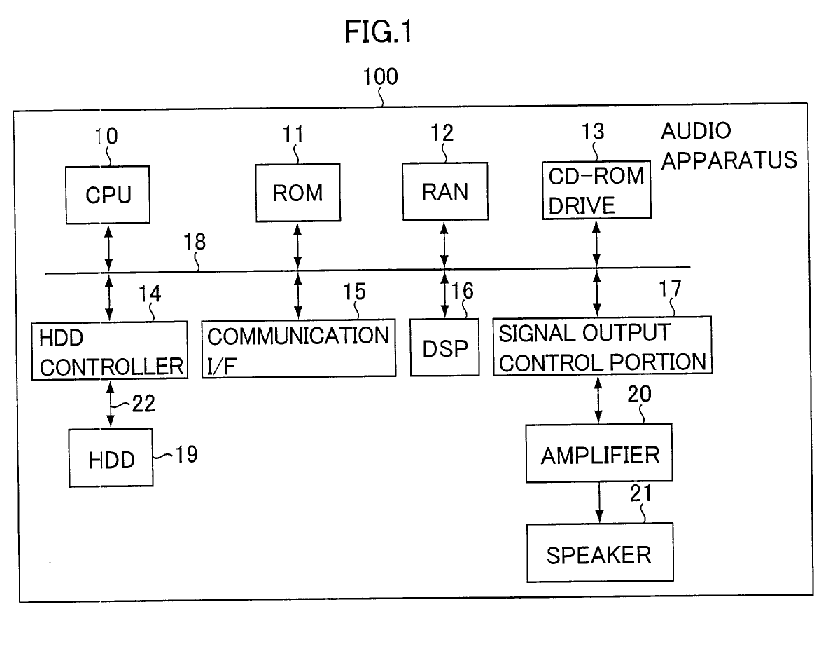

At first FIG. 1 is a block diagram showing an entire structure of an audio apparatus 100 according to a first embodiment of the present invention. As shown in this drawing, the audio apparatus 100 includes a CPU (Central Processing Unit) 10, an ROM (Read Only Memory) 11, an RAM (Random Access Memory) 12, a CD-ROM (Compact Disc Read Only Memory) drive 13, an HDD (Hard Disk Drive) controller 14, a communication interface (I/F) 15, a DSP (Digital Signal Processor) 16 and a signal output control portion 17, those of which are connected to each other through a bus 18. In this embodiment, the bus 18 having a bus width of 16 bits is used, and a data word consisting of 16 bits can be transmitted at once between the respective blocks connected to the bus 18. Incidentally, the bus width of the bus 18 is not restricted to 16 bits, and any bus which can simultaneously transmit a plurality of parallel bits can suffice, and a 32-bit bus or the like may be used alternatively.

The CPU (controller) 10 controls each blocks of the audio apparatus 100. The ROM 11 stores therein various kinds of programs for DSP and various data for DSP, a firmware program which controls the basic operation of the audio apparatus 100, various kinds of control programs and others. The ROM 11 reads programs or the like stored in the CPU 10 and executes various kids of control processing. The RAM 12 temporarily stores various kinds of data and functions as a working area of the CPU 10.

The CD-ROM drive 13 reads digital data recorded on a CD and fetches it into the audio apparatus 100. The HDD controller 14 is connected to the bus 18 and also connected to a hard disk drive (data storage device) 19 through a bus 22. The HDD controller 14 controls recording of data to the hard disk drive (HDD) 19 or reading of data stored in the hard disk drive 19 under control of the CPU 10.

The communication interface 15 is an interface which transmits/receives data with respect to an external device. For example, data can be transmitted/received with various kinds of external drive devices, audio devices, a personal computer or other devices through the communication interface 15. Furthermore, the audio apparatus 100 can transmit/receive data with a device connected to a communication network such as the Internet or a LAN (Local Area Network) through the communication interface 15.

In this audio apparatus 100, audio data used for reproducing music or the like read from the CD-ROM drive 13 or audio data acquired from an external device through the communication interface 15 can be stored in the hard disk drive 19.

The DSP 16 reads programs for DSP or data stored in the ROM 11 and executes various kinds of processinq. e.g., giving an acoustic effect to the audio data read from the hard disk drive 19 or the like under control of the CPU 10.

The signal output control portion 17 outputs an audio signal to which an effect or the like is applied by the DSP 16 as described above to an amplifier 20, or other signal output terminal. The amplifier 20 amplifies an audio signal supplied from the signal output control portion 17 and outputs the amplified audio signal to a speaker 21. The speaker 21 generates sounds in accordance with the audio signal supplied from the amplifier 20.

The audio apparatus 100 according to this embodiment can acquire audio data when the CD-ROM drive 13 reads a music CD which is legally obtained by purchase or the like by a user, and can acquire audio data based on a legitimate right from an external server which carries out a music distribution service or the like through the communication interface 15. Furthermore, the legally acquired audio data can be stored in the hard disk drive 19, and the audio data stored in the hard disk drive 19 can be read and used when reproducing music or outputting the audio data.

Since the audio apparatus 100 can store the audio data in the hard disk drive 19 and utilize the same, it is convenient for a user. However, when the hard disk drive 19 is removed from the audio apparatus 100 and connected to a personal computer or the like by an abuser, the audio data stored in the hard disk drive 19 may be possibly read and illegally copied to any other storage device or storage medium. The audio apparatus 100 according to this embodiment has a structure which restrains recorded data from being illegally copied when the hard disk drive 19 is removed. The structure for prohibiting the illegal copy will now be described in detail hereinafter.

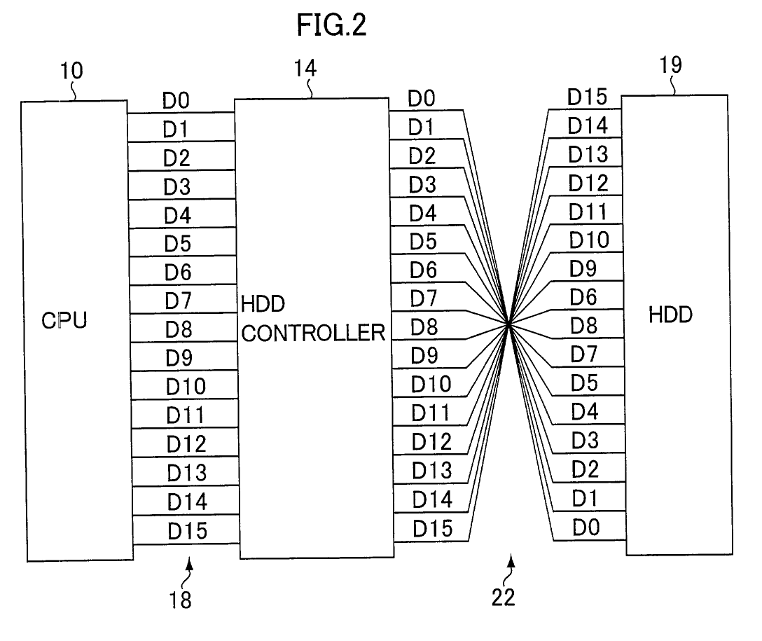

Here, FIG. 2 is a view showing a structure of transmitting data between the CPU 10, the HDD controller 14 and the hard disk drive 19 in the audio apparatus 100. As shown in the drawing, the CPU 10 and the HDD controller 14 are wire-connected to each other by the bus 18 having a bus width of 16 bits, and the HDD controller 14 and the hard disk drive 19 are also wire-connected by the bus 22 having a bus width of 16 bits which is similar to the bus 18.

The bus 18 connecting with the CPU 10 has the wire connection structure similar to that of a general bus. When a data word consisting of a bit set whose bit order is D0, D1, D2, . . . , D15 is transmitted from the CPU 10 to the HDD controller 14, the HDD controller 14 receives the data in the order of D0 (which means a signal consisting of one bit), D1, D2, . . . , D15.

On the other hand, the bus 22 which connects the HDD controller 14 with the hard disk drive 19 has a crossed wire connection structure. When the data word consisting of a bit set whose order is D0, D1, D2, . . . , D15 is transmitted from the HDD controller 14 to the hard disk drive 19, the hard disk drive 19 receives this data word in the order of D15, D14, D13, . . . , D0. That is, the switching pattern of the bus 22 inverts the order of the bit set corresponding to the bus width in such a manner that a connection path used for inputting/outputting the most significant bit (MSB) on the HDD controller 14 side is wire-connected with an opposite connection path used for inputting/outputting a least significant bit (LSB) in the hard disk drive 19. In this manner, the bus 22 which inverts the order of the bit set can be formed by, a wiring pattern formed on a base board having the HDD controller 14 mounted thereon.

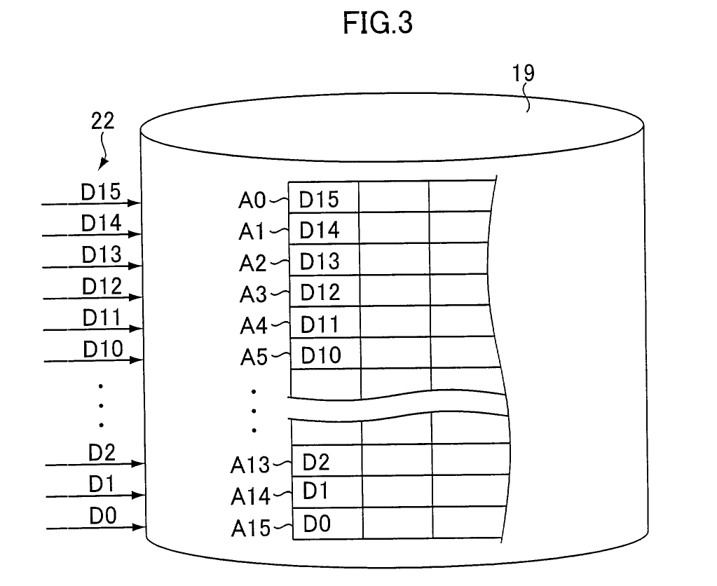

In cases where the HDD controller 14 is wire-connected with the hard disk drive 19 by using the above-described bus 22, when a data word consisting of a bit set whose order is D0, D1, D2, . . . , D15 is supplied from the CPU 10 to the hard disk drive 19 through the HDD controller 14, bit data D15 which has been originally transmitted from the CPU 10 as the LSB is supplied to the connection end at which the MSB is inputted in the hard disk drive 19 as shown in FIG. 3. Therefore, in the hard disk drive 19, the bit data D15 is written in an area A0 in which the MSB should be written. Furthermore, D14 which is originally the 15th bit data is supplied to the connection end at which the second bit data is inputted. In the hard disk drive 19, thus, the bit data D14 is recognized as the second data and written in an area A1 in which the second bit data should be recorded. Thereafter, similarly, other input bit data is also written in a predetermined recording area in the hard disk drive 19 as bit data whose order is inverted from the order recognized on the CPU 10 side. For example, a bit D13 which is originally the 14th bit data is written in the A2 in which the third bit data should be recorded, and D12 which is originally the 13th bit data is written in the A3 in which the fourth bit data should be recorded.

Incidentally, all the data is recorded in the hard disk drive 19 in the form of a bit set whose order is different from that recognized by the CPU 10 or the HDD controller 14 side as described above. The order of a bit set of control data other than contents data (for example, control data such as control commands or status information used by the CPU 10 or the HDD controller 14 in order to control the hard disk drive 19) also is counterchanged, and this control data is then supplied. In the hard disk drive 19 according to this embodiment, therefore, the register bit definition of control data determined by the built-in controller of the HDD drive 19 is set in accordance with the inverse order. By doing so, when the hard disk drive 19 receives the control data whose bit order is different from that of the original data outputted from the HDD controller 14, the control data can be processed correctly as the right data having the original bit order.

In this manner, the contents data (for example, audio data) supplied from the CPU 10 is recorded in the hard disk drive 19 as the scrambled data having a bit order different from the original order recognized in the CPU 10. In case of reading the scrambled data whose order is changed in this way and recorded in the hard disk drive 19, the CPU 10 instructs reading of data specified by a user or the like to the built-in controller of the hard disk drive 19 through the HDD controller 14. In the hard disk drive 19 which has accepted this instruction, the built-in controller sequentially outputs bit data stored in its recording area. Here, in the hard disk drive 19, the recording area A0 is an area used for recording bit data of the MSB, the recording area A1 is an area used for recording the second bit data, and the recording areas A2, A3, . . . , A15 are areas used for recording the third, fourth, . . . , 16th bit data, respectively. Therefore, the built-in controller of the hard disk drive 19 outputs the bit data stored in the respective areas in the order of the recording areas A0, A1, A3, . . . , A15. Accordingly, from the hard disk drive 19, the bit data D15 is supplied to the end connected to the bus 22 from which the MSB is outputted, and the bit data D14 is supplied to the end connected to the bus 22 from which the second bit data is outputted. Similarly, subsequent data bits are supplied to the connection ends corresponding to the order for outputting the respective bit data in such a manner that the data has the bit order of the bit data D13, . . . , D1, D0.

The data consisting of the bit set outputted from the hard disk drive 19 the order of D15, D14, D13, . . . , D0 as described above is concurrently transmitted to the HDD controller 14 every 16 bits by the bus 22. In this embodiment, since the bus 22 has the wire connection structure which inverts the order of 16 bits as described above, the bit data outputted from the hard disk drive 19 having the bit order of D15, D14, . . . , D0 is inputted as the data consisting of the bit set whose order is inverted in the HDD controller 14. That is, in the HDD controller 14, the bit data D0 is supplied to the end connected to the bus 22 used for inputting the MSB, and the bit data D1 is supplied to the connection end used for inputting the second bit data. Similarly, each bit data is supplied to the connection end used for inputting the bit data in the corresponding order in such a manner that the data can be recognized as the correct data with the bit order of the bit data D2, D3, . . . , D15. Therefore, the data which has been recorded in the hard disk drive 19 with its order being inverted from that of the original data is recognized as the data with the original bit order in the HDD controller 14, and supplied to the CPU 10 through the bus 18 as the data with the original bit set order. As a result, the CPU 10 can use the data read from the hard disk drive 19 for music reproduction processing or the like without executing processing of counterchanging the bit set.

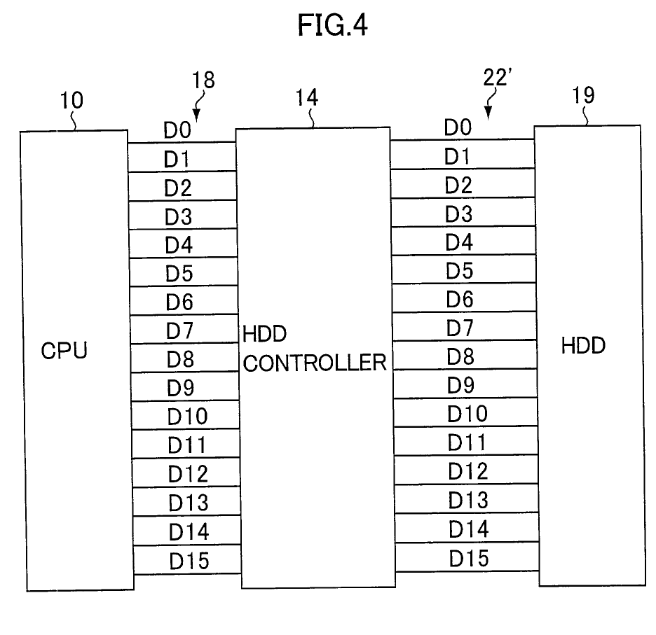

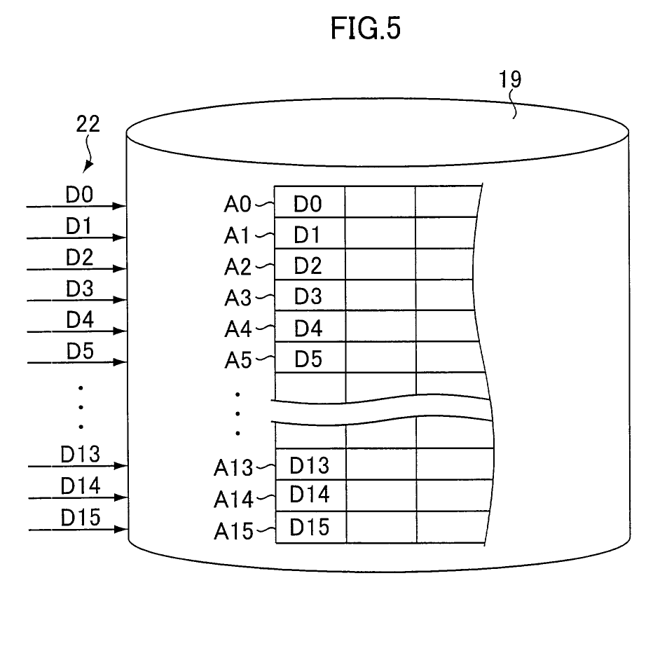

On the other hand, as shown in FIG. 4, in cases where the hard disk drive 19 and the HDD controller 14 are connected to each other by using a bus 22′ having a regular straight wire connection structure similar to that of a general bus, the bit data D0 transmitted from the CPU 10 as the MSB is recognized as the MSB and written in the area A0 where the MSB should be recorded in the hard disk drive 19 as shown in FIG. 5. Moreover, D1 transmitted as the second bit data from the CPU 10 is recorded in the area A1 where the second bit data should be recorded. In addition, other bit data outputted from the CPU 10 is written in a predetermined recording area in the hard disk drive 19 as the bit data in the regular order. For example, D2 which is originally the third bit data is written in the A2 where the third bit data should be recorded, and D3 which is originally the fourth bit data is written in the A3 where the fourth bit data should be recorded.

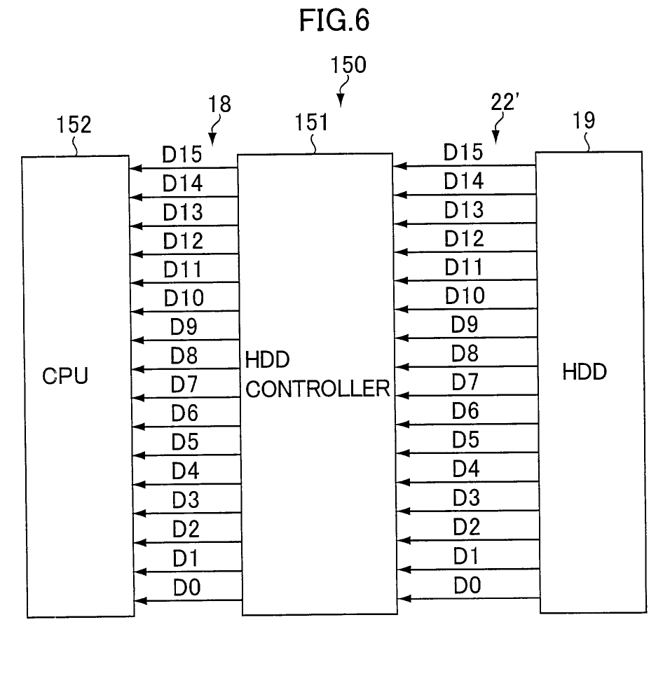

As described above, in the audio apparatus 100 according to this embodiment, as different from the case where the HDD controller 14 and the hard disk drive 19 are connected to each other by using the regular bus 22′, audio data or the like acquired by the CD-ROM drive 13 or the communication interface 15 is recorded in the hard disk drive 19 as scrambled data with a bit order different from that of the original bit stream data. Therefore, even if this hard disk drive 19 is removed from the audio apparatus 100 and connected to any other machine (for example, a personal computer), it is possible to restrain data recorded in the hard disk drive 19 from being read and illegally copied. More specifically, as shown in FIG. 3, in the audio apparatus 100 according to this embodiment, the data whose original order is D0, D1, D2, . . . , D15 is recorded in the hard disk drive 19 as scrambled data whose order is D15, D14, . . . , D0. As shown in FIG. 6, therefore, when this hard disk drive 19 is removed from the audio apparatus 100 and connected to another HDD controller 151 in another apparatus 150 by using the regular bus 22′, the data whose order is D15, D14, D13, . . . , D0 is outputted from the hard disk drive 19 to the bus 22′. Therefore, the HDD controller 151 which has received the data from the hard disk drive 19 through the bus 22′ recognizes it as the data whose order is different from the original order of D15, D14, D13, . . . , D0 and outputs the scrambled data as it is whose bit order is different from the original order to the CPU 152 or the like. Accordingly, in this apparatus 150, the data recorded in the hard disk drive 19 cannot be utilized, and it is possible to restrict copy or the like of the data recorded in the hard disk drive 19.

In addition, in the audio apparatus 100 according to this embodiment, illegal copy of the data recorded in the hard disk drive 19 can be suppressed as described above, and such suppression of illegal copy can be realized by the simple wire connection structure of the bus 22 which can counterchange the order of bits as described above. Such a wire connection structure of the bus 22 can be realized by an easy operation which does not require a new process or the like, e.g., by forming a wiring pattern different from that of a regular bus pattern on a base circuit board.

Additionally, in this embodiment, the CPU 10 or the HDD controller 14 does not need to execute data conversion processing, e.g., encryption or scrambling of data in order to restrain data recorded in the hard disk drive 19 from being illegally copied. Therefore, a speed of reading or writing data from/to the hard disk drive 19 is not delayed by processing such as encryption (decryption). Further, in this embodiment, a special file system for data management in the hard disk drive 19 does not have to be developed, and illegal copy of data can be restrained even if a general-purpose file system is used for managing files in the hard disk drive 19.

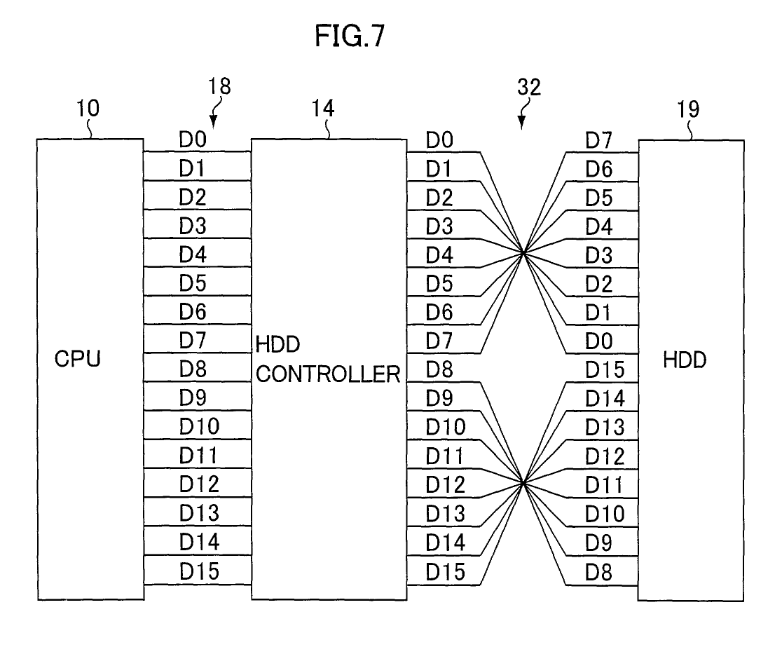

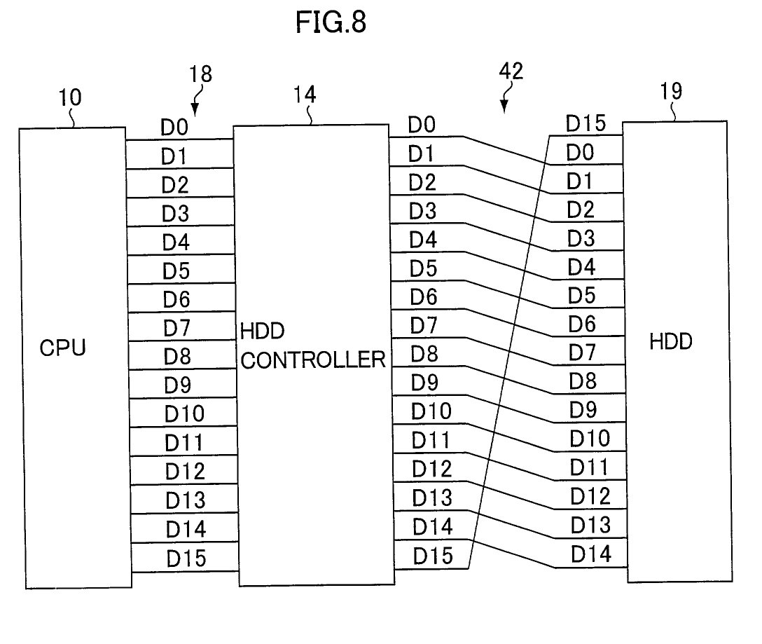

Incidentally, in the above-described first embodiment, although the bus 22 has a wire connection structure by which the order of the bit set of data transmitted between the HDD controller 14 and the hard disk drive 19 is inverted, the present invention is not restricted to such a wire connection structure, and a wire connection structure which enables data transmission between the HDD controller 14 and the hard disk drive 19 in which the order of the bit set of data becomes disarranged can suffice. For example, as shown in FIG. 7, it is possible to use a bus 32 having a wire connection structure by which data is recognized with the original order of D0, D1, D2, D3, . . . , D15 on the HDD controller 14 side, and the same data is recognized and recorded as scrambled data with the order of D7, D6, D5, . . . D0, D15, D14, . . . , D8 on the hard disk drive 19 side. Moreover, as shown in FIG. 8, it is also possible to use a bus 42 having a wire connection structure, by which the data is recognized with the original order of D0, D1, D2, D3, . . . , D15 on the HDD controller 14 side, and the same data is recognized and recorded as scrambled data with the order shifted or staggered from the original data order, i.e., D15, D0, D1, D2, . . . , D14 on the hard disk drive 19 side. In addition, besides inverting or shifting the order in this manner, a wire connection structure by which data is recorded on the hard disk drive 19 side as data with the irregular order may be adopted, and a wire connection structure by which the data is recognized in the hard disk drive 19 with the bit order different from the original data bit order can suffice.

B. Second Embodiment

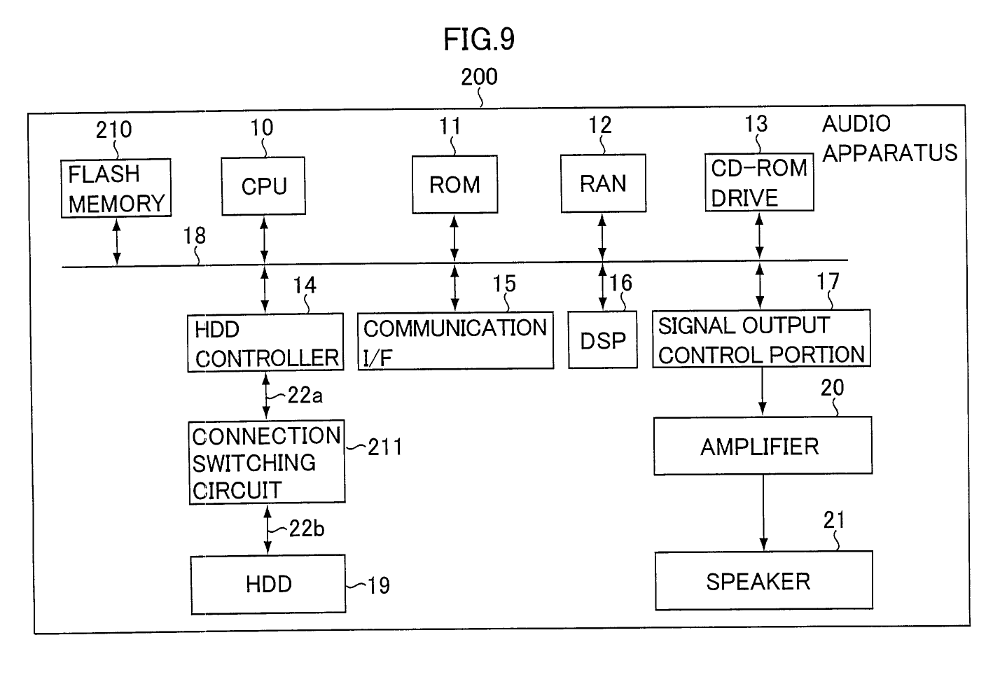

FIG. 9 shows an entire structure of an audio apparatus 200 according to a second embodiment of the present invention. Incidentally, in the second embodiment, like reference numerals denote constituent elements common to the first embodiment, thereby omitting their detailed explanation.

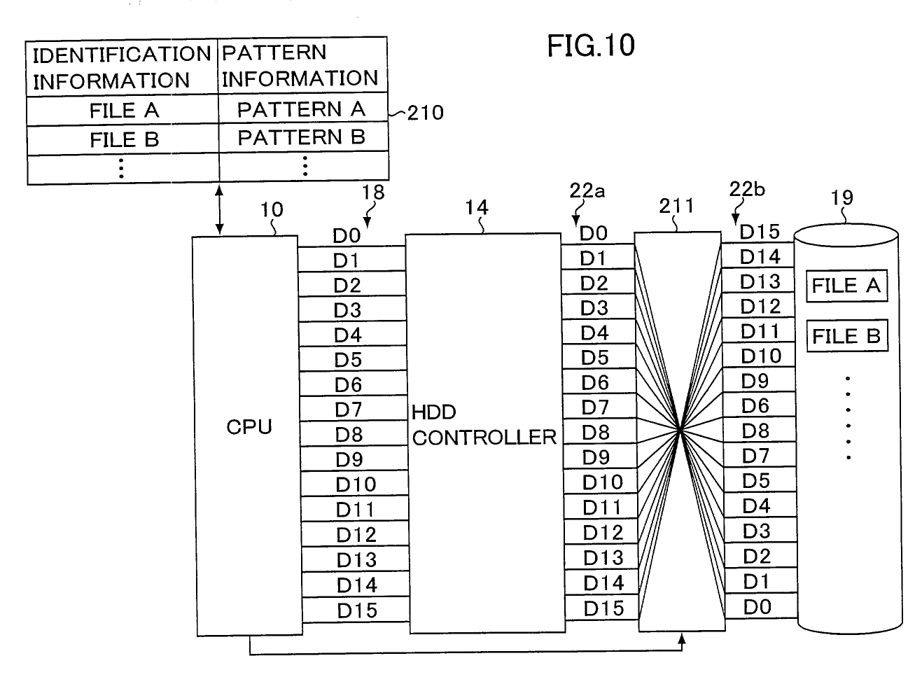

As shown in FIG. 9, the audio apparatus 200 according to the second embodiment includes a flash memory 210 connected to a bus 18, and a connection switching circuit 211 provided between a bus 22a and a bus 22b, in addition to the structure of the audio apparatus 100 according to the first embodiment. In the audio apparatus 200 according to the second embodiment, as similar to the first embodiment, data acquired by a CD-ROM drive 13 or a communication interface 15 (for example, audio data used for reproducing music) can be likewise recorded in a hard disk drive 19 so as to be capable of restraining illegal copy or the like under control of a CUP 10. Description will now be given as to such a structure regarding data transmission between the hard disk drive 19 and the CPU 10 with reference to FIG. 10 and FIG. 9 cited above.

In the audio apparatus 200 according to the second embodiment, although establishment of wire connection between the CPU 10 and an HDD controller 14 by the bus 18 having a bus width of 16 bits is similar to the first embodiment, the HDD controller 14 and the hard disk drive 19 are wire-connected to each other by the bus 22a and the bus 22b each having a bus width of 16 bits and the connection switching circuit 211 connected between these buses.

The connection switching circuit 211 is a circuit constituting 16 path connections between the bus 22a and the bus 22b, and the switching pattern can be changed by control of the CPU 10. As such a connection switching circuit 211 capable of changing the switching pattern, it is possible to use a circuit which can define the path structure by programming, e.g., PLD (Programmable Logic Device) or FPGA (Field Programmable Gate Array).

The flash memory (pattern information storing means) 210 is prepared with areas for storing therein identification information for identifying each data block (which is a file constituting one set of music data in the following description) to be recorded in the hard disk drive 19 and pattern information indicative of a switching pattern of the connection switching circuit 211 when a file identified by the identification information is recorded in association with each other. Incidentally, in this embodiment, although the flash memory 210 is used as a storage medium which stores therein the identification information and the pattern information, the present invention is not restricted thereto, any storage medium capable of rewriting other than the hard disk drive 19 in which data is recorded can suffice, and various kinds of mediums such as any other hard disk, an RAM or a floppy disk can be used.

In the second embodiment, the CPU 10 performs the following processing when recording data in the hard disk drive 19 and when reading data recorded in the hard disk drive 19 by executing a group of data recording/reading processing programs stored in the ROM 11.

At first, in case of recording a file of audio data used for reproducing one given song acquired by the CD-ROM drive 13 or the communication interface 15 in the hard disk drive 19, the CPU 10 writes the identification information used for identifying the file in an area where the identification information of the flash memory 210 is to be stored, and also writes information indicative of a switching pattern of the connection switching circuit 211 when recording the file in an area where the pattern information corresponding to the former area is recorded. Here, it is good enough that the CPU 10 appropriately selects a switching pattern of the connection switching circuit 211 from a plurality of provisionally prepared switching patterns by using a random number or the like. As a plurality of the thus prepared connection patterns, there may be a pattern by which a bit order is inverted as with the first embodiment, a switching pattern by which data is recognized and recorded as scrambled data with the order of D7, D6, D5, . . . , D0, D15, D14, . . . , D8 in the hard disk drive 19 (see FIG. 7), a switching pattern by which data is recognized and recorded as staggered data whose order is shifted from that of the original data, i.e., D15, D0, D1, D2, . . . , D14 in the hard disk drive 19 (see FIG. 8), a switching pattern by which data is recognized as disarranged data with an irregular order in the hard disk drive 19, and others. Preparing various kids of such patterns can suffice.

Incidentally, although the CPU 10 may select a switching pattern by using a random number as described above, the CPU 10 may select a switching pattern in accordance with an instruction from a user, and its selection method is arbitrary.

When the identification information and the pattern information are written in the flash memory 210, the CPU 10 outputs a control signal to the connection switching circuit 211 so that the connection switching circuit 211 is set to a dedicated switching pattern for identification information previously stored in the ROM 11 and outputs only bit sets indicative of the identification information of a file to be recorded to the hard disk drive 19 through the HDD controller 14, the bus 22a, the connection switching circuit 211 and the bus 22b. As a result, the bit set indicative of the identification information whose order is controlled by the dedicated identification information recording switching pattern set to the connection switching circuit 211 is transferred and recorded. Here, as the dedicated identification information recording switching pattern, it may be possible to use a pattern which does not change the order, namely, a pattern having a wire connection structure similar to that in case of general bus connection, or a pattern by which the order of the bit set is inverted.

Upon completing transfer of the identification information to the hard disk drive 19 in this manner, the CPU 10 outputs a control signal to the connection switching circuit 211 so that the connection switching circuit 211 is set to the pattern indicated by the switching pattern information written in a pattern information storage area of the flash memory 210, and sets the switching pattern of the connection switching circuit 211. When the switching pattern of the connection switching circuit 211 is set in this way, the CPU 10 outputs data of the object file to the hard disk drive 19 through the HDD controller 14. For example, as shown in FIG. 10, if the switching pattern set to the connection switching circuit 211 causes inversion of the order of the bit set as similar to the first embodiment, the data outputted from the CPU 10 in the bit order of D0, D1, D2, . . . , D15 is transferred as scrambled data whose order is inverted as D15, D14, D13, . . . , D0 in the hard disk drive 19, and it is recorded as the inverted data whose bit order is inverted as similar to the embodiment (see FIG. 3).

On the other hand, in case of reading the data recorded in the hard disk drive 19, the CPU 10 first controls the hard disk drive 19 through the HDD controller 14 so as to read the identification information of the file which has been specified by a user. Here, when supplying such control data for instructing reading to the hard disk drive 19, the CPU 10 outputs a control signal to the connection switching circuit 211 so that the connection switching circuit 211 is set to a provisionally prepared specific switching pattern for control data transmission, and transmits the control data consisting of bit sets to the hard disk drive 19 with the connection switching circuit 211 being set to this specific switching pattern for control data transmission. As a result, to the hard disk drive 19 is supplied the bit set indicative of the control data whose order is controlled by the specific control data transmission switching pattern set in the connection switching circuit 211. Here, as the specific control data transmission switching pattern, there may be used a pattern which does not change the order, namely, a pattern having a straight wire connection structure similar to that of general bus connection or another pattern which causes inversion of the order of the bit set. Although such a pattern is arbitrary, if the order of the bit set is changed by this pattern, a register bit definition of the HDD 19 must be set to one corresponding to the changed order so that the built-in controller of the hard disk drive 19 can perceive a control command which is indicated by the data consisting of the changed bit set.

When the control data is transmitted to the hard disk drive 19 in this manner, the CPU 10 outputs a control signal to the connection switching circuit 211 so that the connection switching circuit 211 is set to the above-described dedicated switching pattern for identification information recording. As a result, a bit set of data indicative of the identification information used for identifying the specified file is read from the hard disk drive 19, and it is supplied to the CPU 10 as data (original data) consisting of the bit set whose order is completely the same as that of the original bit set. For example, if a pattern by which the order of the bit set is not changed, namely, a pattern having the wire connection structure similar to that of general bus connection is adopted as the dedicated identification information recording switching pattern, the order of a bit set of data which is read from the hard disk drive 19 and supplied to the CPU 10 of course remains unchanged. Even if the dedicated identification information recording pattern in recording of the hard disk drive 19 is a pattern which causes inversion of the order of a bit set (the order of data recorded in the hard disk drive 19 is inverted), it can be supplied to the CPU 10 as right data consisting of a bit set with the original order by setting this dedicated pattern at the time of reading. As a result, the CPU 10 can perceive the identification information by making reference to the read bit set.

The CPU 10 makes reference to the flash memory 210, and specifies the pattern information corresponding to the identification information which has been read from the hard disk drive 19 and perceived as described above. The CPU 10 outputs a control signal to the connection switching circuit 211 in such a manner that the connection switching circuit 211 is set to the switching pattern indicated by the thus specified pattern information. When the corresponding switching pattern of the connection switching circuit 211 is set, bit sets of data constituting the specified file is supplied from the hard disk drive 19 to the CPU 10 through the bus 22b, the connection switching circuit 211, the bus 22a and the HDD controller 14. By setting the connection switching circuit 211 to the pattern indicated by the thus specified identification information, i.e., the pattern which is the same as that when recording the data and by reading the data from the hard disk drive 19, the bit set of the data of the specified file is supplied to the CPU 10 as the original data consisting of the bit set whose order is completely the same as that of the original bit set. For example, when the switching pattern indicated by the specified pattern information is a pattern which causes inversion of the order of the bit set (the order of the data recorded in the hard disk drive 19 is inverted), it can be supplied to the CPU as data consisting of a bit set with the original order by setting this pattern.

As described above, in the audio apparatus 200 according to the second embodiment, since the switching pattern of the connection switching circuit 211 can be set in accordance with each file to be recorded in the hard disk drive 19, the detail of changing the order of a bit set of data to be recorded in the hard disk drive 19 can be set in accordance with each file. For example, a given file is recorded in the hard disk drive 19 as data consisting of a bit string whose order is inverted from that of the bit string of the original data, and any other file is recorded in the hard disk drive 19 as data consisting of a bit set whose order is shifted from that of the bit set of the original data. By doing so, even if this hard disk drive 19 is removed separately from the audio apparatus 200 and connected to any other machine (for example, a personal computer), it is possible to restrain data recorded in the hard disk drive 19 from being read and illegally copied. For example, when the order change manner (inverting the order of the bit set) of the bit set of the data recorded in the hard disk drive 19 with respect to the original bit set was found in a given file, the original data in this file can be restored by inverting the bit set of the data recorded in the hard disk drive 19. However, regard to another file recorded by shifting the order of the bit set of the original data, the original data cannot be obtained even if processing for restoring the found order change manner (processing for inverting the order) is carried out. By enabling the variable setting of the order change manner of the bit set of the data recorded in the hard disk drive 19 in accordance with each file, suppression of illegal copy can be further assuredly realized as compared with the first embodiment.

Furthermore, in the audio apparatus 200 according to the second embodiment, the data recorded in the hard disk drive 19 can be restrained from being illegally copied as described above, and such suppression of illegal copy is realized by simple control processing, e.g., controlling the switching pattern of the connection switching circuit 211. Therefore, since the CPU 10 or the HDD controller 14 does not have to perform data conversion processing such as encryption or scrambling of data in order to suppress illegal copy of data recorded in the hard disk drive 19, a speed of reading or writing data from/to the hard disk drive 19 is not delayed by processing such as encryption (decryption). Moreover, as similar to the first embodiment, even if files in the hard disk drive 19 are managed by using a general-purpose file system, illegal copy of data can be restrained.

In addition, in the audio apparatus 200 according to the second embodiment, information indicative of the switching pattern by which each file is set for recording is recorded in a flash memory 210 which is different from the hard disk drive 19 in which the data is recorded. Therefore, since information concerning the switching pattern is not recorded in the hard disk drive 19, it is hard to decrypt the switching pattern used in recording each file when the hard disk drive 19 is removed from the audio apparatus 200, thereby further suppressing illegal copy of data.

Incidentally, in the second embodiment, the switching pattern used for recording/reading is changed in accordance with each data file for one song. Alternatively the switching pattern may be changed in accordance with predetermined blocks of data as well as each data file for one song. For example, a group of data files for a plurality of songs (for example, data files including all songs in a music album) may be determined as a block, and the switching pattern may be changed in accordance with each file group including a plurality of song data files.

C. Modification

It is to be noted that the present invention is not restricted to the above-described embodiment and the following various modifications are possible.

(Modification 1)

In the above-described second embodiment, although the switching pattern of the connection switching circuit 211 can be set in accordance with each file, the connection switching circuit 211 may be set to one given switching pattern and the set switching pattern may be prevented from fluctuating when manufacturing the audio apparatus 200. In this case, in a process of manufacturing the audio apparatus 200, even though all the audio apparatuses 200 are of the same type, the order change content of a bit set of data recorded in the hard disk drive 19 differs in accordance with each apparatus by setting an arbitrarily set switching pattern in accordance with each audio apparatus 200. By doing so, in cases where the order change content of a given apparatus was found, data consisting of a bit set with the original order can not be restored in another apparatus which is of the same type even if the bit set of the data read from the hard disk drive 19 is counterchanged by utilizing the found content, and decryption of the order change content is thus difficult. Therefore, the possibility of illegal copy of data recorded in the hard disk drive 19 is lowered.

Meanwhile, by changing the wiring pattern on the base board in accordance with each apparatus as described in the first embodiment, the order change content of the bit set can be changed in accordance with each apparatus even though all the apparatuses are of the same type as described in connection with this modification. However, changing the wiring pattern in accordance with each apparatus leads to complication of the manufacturing process. On the contrary, as with this modification, when the set content of the switching pattern obtained by the connection switching circuit 211 is changed in view of software by programming, e.g., PLD or FPGA inherent to the device, the hardware manufacturing process becomes uniform if all the apparatuses are of the same time, which does not result in complication of the manufacturing process.

Additionally, although the connection switching circuit 211 may be set to one switching pattern, the switching pattern set to the connection switching circuit 211 may be changed alter. As a timing for changing the switching pattern, for example, the switching pattern is automatically changed to another pattern when data recorded in the hard disk drive 19 is eliminated by initializing processing or the like.

(Modification 2)

Further, in the above-described second embodiment, a given file is written in the hard disk drive 19, and the identification information which identifies that file and the pattern information indicative of the switching pattern set in recording that file are written in the flash memory 210. When reading that file from the hard disk drive 19, the switching pattern which is set in the connection switching circuit 211 is determined by making reference to the flash memory 210. The switching pattern can be set in accordance with each file by such a technique, but the switching pattern of the connection switching circuit 211 may be set in accordance with each file by another technique.

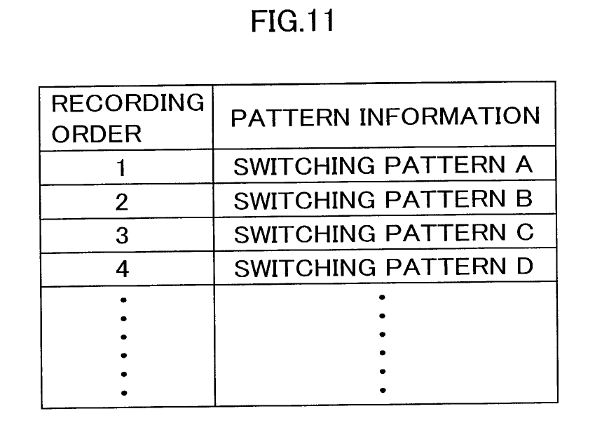

Concretely exemplifying another technique, as shown in FIG. 11, the order of recording in the hard disk drive 19 and the switching pattern set in the connection switching circuit 211 when recording a file with that order are stored in the ROM 11 or the like in advance. For example, a switching pattern A is used for a file which is recorded in the hard disk drive 19 at first, a switching pattern B is used for a file which is recorded at second, and a switching pattern C is used for a file which is recorded at third. Further, in accordance with such a content stored in the ROM 11, the CPU 10 sets the connection switching circuit 211 to the switching pattern A and executes recording when recording the first file, and sets the connection switching circuit 211 to the switching pattern B and executes recording when recording the next file (second file).

On the other hand, in case of reading a file recorded in the hard disk drive 19 in this manner, the CPU 10 judges the order of recording the file specified by a user. Then, the CPU 10 makes reference to the ROM 11, specifies the switching pattern corresponding to the found order, and sets the connection switching circuit 211 to the specified switching pattern. In the above example, when reading of the second file is specified by a user, the connection switching circuit 211 is set to the switching pattern B, and the secondly recorded file is read from the hard disk drive 19 in this state. As a result, since reading can be executed in the state that the connection switching circuit 211 is set to the same switching pattern as that used in recording, the CPU 10 can utilize the read data as it is without applying processing of, e.g., counterchanging the bit set of this data.

(Modification 3)

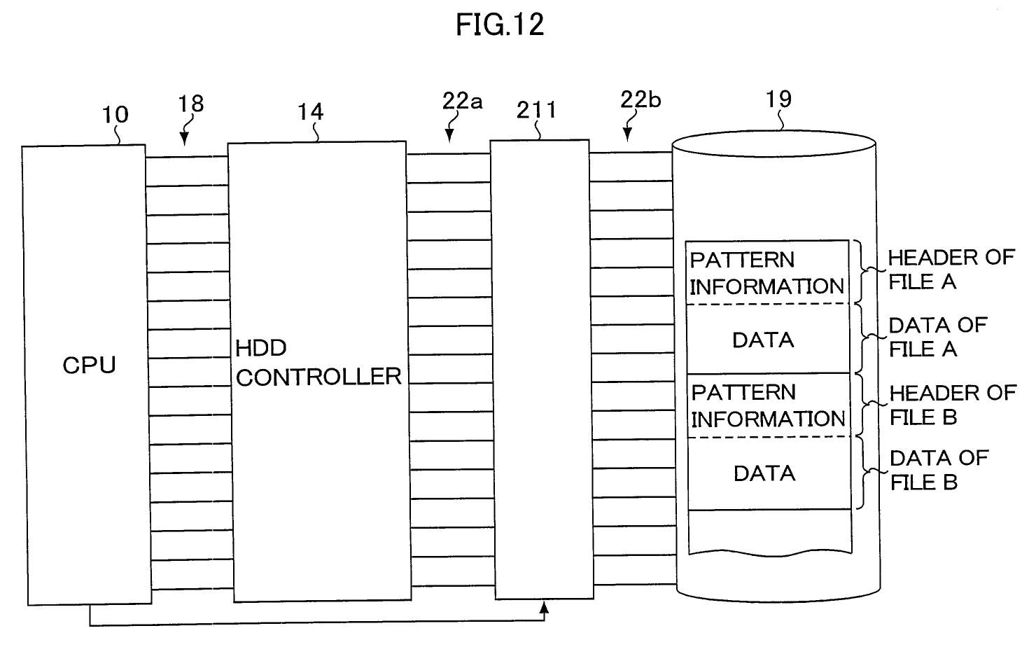

Furthermore, as a technique for setting the switching pattern in accordance with each file as similar to the second embodiment, the following technique may be adopted. That is, in the second embodiment, although the flash memory 210 which stores the identification information identifying each file and the pattern information in association with each other is used, the flash memory 210 may not be utilized and a header of a file stored in the hard disk drive 19 may include pattern information indicative of which switching pattern is used to transfer data, as shown in FIG. 12.

As depicted in this drawing, in this modification, when storing data of a given file (file A) in the hard disk drive 19 from the CPU 10 through the HDD controller 14 and the connection switching circuit 211, the CPU 10 determines a switching pattern used for transferring the file A by using a random number or the like, provides a header for pattern identification to the file A (provides a dedicated header used only in the apparatus in addition to the originally set header), and writes in the header the pattern information indicative of a switching pattern set to the connection switching circuit 211 when transferring data of the thus determined file A to the hard disk drive 19. Then, the CPU 10 outputs a control signal to the connection switching circuit in such a manner that the connection switching circuit 211 is set to a switching pattern for transferring a preset header portion, e.g., a pattern which does not cause counterchanging of the order of a bit set, and sets the connection switching circuit 211 to the switching pattern for header portion transfer. In this state, the CPU 10 transfers only the header portion of the file A to the hard disk drive 19 through the HDD controller 14 and the connection switching circuit 211, and only the header portion including the pattern information is consequently stored in the hard disk drive 19. Thereafter, the CPU 10 outputs a control signal so that the connection switching circuit 211 is set to the switching pattern indicated by the pattern information written in the header portion, and sets the connection switching circuit 211 to the switching pattern indicated by the pattern information included in the header portion. Subsequently, the CPU 10 transfers a data portion of the file A to the hard disk drive 19 through the HDD controller 14 and the connection switching circuit 211, and the file A in which the header portion and the data portion are combined is consequently stored in the hard disk drive 19. Here, the data portion is stored as data consisting of the bit set whose order is counterchanged by the switching pattern indicated by the pattern information.

Then, description will now be given as to reading the file A which has been transferred by utilizing the switching pattern having different header and data portions as described above and stored in the hard disk drive 19. When reading the file A in response to an instruction from a user, the CPU 10 first outputs a control signal to the connection switching circuit in such a manner that the connection switching circuit 211 is set to a switching pattern for header portion transfer, and sets the connection switching circuit 211 to the switching pattern for header portion transfer. In this state, the CPU 10 reads only the header portion of the file A from the hard disk drive 19 through the connection switching circuit 211 and the HDD controller 14. That is, the CPU 10 reads the header portion from the hard disk drive 19 by using the same switching pattern as that used in transfer to the hard disk drive 19, and it can hence perceive the pattern information included in the read header portion. When the CPU 10 perceives the pattern information included in the header portion, it outputs a control signal in such a manner that the connection switching circuit 211 is set to a switching pattern indicated by the pattern information, and sets the connection switching circuit 211 to the switching pattern indicated by the pattern information included in the header portion. Then, the CPU 10 reads a data portion of the file A from the hard disk drive 19 through the connection switching circuit 211 and the HDD controller 14. That is, the CPU 10 reads the data portion from the hard disk drive 19 by using the same switching pattern as that used in transfer to the hard disk drive 19, and it can consequently use the read data portion as regular data without applying processing, e.g., encryption or counterchanging of the order to the read data portion. Moreover, when the CPU 10 recognized reading of the data portion and reading of last data in the data portion (EOF (End of File) detecting data or the like), the CPU 10 outputs a control signal to the connection switching circuit in such a manner that the connection switching circuit 211 is set to a switching pattern for header portion transfer, and prepares for reading another file.

(Modification 4)

In addition, as a technique for setting a switching pattern for each file as similar to the second embodiment, the following technique may be adopted. That is, in the above modification, although the header portion including the pattern information is transferred by utilizing the switching pattern for header portion transfer, a switching pattern used for transferring the header portion may be changed in accordance with each file.

As shown in the drawing, in this modification, when storing data of a given file (assuming a file A) in the hard disk drive 19 from the CPU 10 through the HDD controller 14 and the connection switching circuit 211, the CPU 10 determines a switching pattern used for transferring the file A by using a random number or the like, provides a header for pattern identification to the file A (provides a dedicated header used only in the apparatus in addition to the originally given header), and writes in the header pattern information indicative of a switching pattern set to the connection switching circuit 211 when transferring data of the determined file A to the hard disk drive 19. Moreover, the CPU 10 determines a switching pattern used for transferring a header portion of the file A by using a random number or the like, and stores in a storage device different from the hard disk drive 19, e.g., a flash memory 210′ pattern information indicative of the determined switching pattern and identification information used for identifying the file A in association with each other. Then, the CPU 10 outputs a control signal to the connection switching circuit in such a manner that the connection switching circuit 211 is set to the determined switching pattern for header portion transfer, and sets the connection switching circuit 211 to the determined switching pattern for header portion transfer. In this state, the CPU 10 transfers only the header portion of the file A to the hard disk drive 19 through the HDD controller 14 and the connection switching circuit 211, and only the header portion including the pattern information is consequently stored in the hard disk drive 19. Thereafter, the CPU 10 outputs a control signal in such a manner that the connection switching circuit 211 is set to the switching pattern indicated by the pattern information written in the header portion, and sets the connection switching circuit 211 to the switching pattern indicated by the pattern information included in the header portion. Then, the CPU 10 transfers data portion of the file A to the hard disk drive 19 through the HDD controller 14 and the connection switching circuit 211, and the file A in which the header portion and the data portion are combined is consequently stored in the hard disk drive 19.

Subsequently, description will now be given as to the case of reading the file A which has been transferred by utilizing a switching pattern having different header and data portions and stored in the hard disk drive 19 as explained above. When reading the file A in response to an instruction or the like from a user, the CPU 10 makes reference to the stored content in the flash memory 210′, outputs a control signal to the connection switching circuit in such a manner that the connection switching circuit 211 is set to a switching pattern indicated by pattern information associated with the file A of identification information, and sets the connection switching circuit 211 to the switching pattern indicated by the pattern information of the flash memory 210′. In this state, the CPU 10 reads only a header portion of the file A from the hard disk drive 19 through the connection switching circuit 211 and the HDD controller 14. That is, the CPU 10 reads the header portion from the hard disk drive 19 by using the same switching pattern as that used in transfer to the hard disk drive 19, and it can consequently perceive the pattern information included in the read header portion. When the CPU 10 perceives the pattern information included in the header portion, it outputs a control signal so that the connection switching circuit 211 is set to a switching pattern indicated by the pattern information, and sets the connection switching circuit 211 to the switching pattern indicated by the pattern information included in the header portion. Then, the CPU 10 reads a data portion of the file A from the hard disk drive 19 through the connection switching circuit 211 and the HDD controller 14. That is, the CPU 10 read the data portion from the hard disk drive 19 by using the same switching pattern as that used in transfer to the hard disk drive 19, and the CPU 10 can consequently utilize the read data portion as regular data without applying processing, e.g., encryption or counterchanging of the order to the read data portion.

By performing the above-described processing, the switching pattern used for transferring the header portion of a file differs in accordance with each file; and reading the switching pattern by an abuser becomes further difficult. Therefore, illegal copy of data stored in the hard disk drive 19 can be suppressed.

(Modification 5)

Further, although description has been given as to the case where the present invention is applied to the audio apparatus in the first and second embodiments, the present invention can be likewise applied to any other electronic apparatus such as a video reproduction/recording apparatus including therein a storage device which stores data, e.g., music data or video data which should be prevented from being illegally copied in many ways.

As described above, according to the present invention, it is possible to restrain illegal copy of data stored in the data storage device with a simple structure without causing reduction in the performance, e.g., reduction in a recording speed or a reading speed of the data storage device even if data management is carried out by using a general-purpose file system or the like.

What is claimed is:

1. An electronic apparatus having a processor for processing data, comprising:
a storage device that stores data arranged in a given order;
a controller that reads the data from the storage device and writes the data into the storage device during the course of the processing of the data by the processor; and
a bus that comprises a set of paths and connects between the storage device and the controller for transferring of the data therebetween through the set of the paths, wherein
the set of the paths are disarranged between the controller and the storage device such that the order of the stored data is changed from the order of the processed data.

2. The electronic apparatus according to claim 1, wherein the storage device stores the data represented by a set of bits arranged in the given order, the bus comprised of the set of the paths enables parallel transferring of the set of the bits, and the set of the paths are disarranged between the controller and the storage device such that the order of the bits of the stored set is changed from the order of the bits of the processed set.

3. The electronic apparatus according to claim 1, wherein the storage device stores the data representative of multimedia contents containing at least one of pictures and music.

4. An electronic apparatus having a processor for processing data, comprising:
a storage device that stores data arranged in a given order;
a controller that reads the data from the storage device and writes the data into the storage device during the course of the processing of the data by the processor;
a bus that comprises a set of paths and connects between the storage device and the controller for transferring of the data therebetween through the set of the paths; and
a switching circuit disposed in the middle of the bus for switching the set of the paths according to a given switching pattern such that the order of the data is altered between the stored data and the processed data in correspondence to the switching pattern.

5. The electronic apparatus according to claim 4, wherein the storage device stores the data represented by a set of bits arranged in the given order, the bus comprised of the set of the paths enables parallel transferring of the set of the bits, and the switching circuit switches the set of the paths according to a given switching pattern such that the order of the bits is altered between the set stored in the storage device and the set processed by the processor in correspondence to the switching pattern.

6. The electronic apparatus according to claim 4, wherein the switching circuit operates during the course of writing blocks of the data into the storage device for switching the paths according to different switching patterns in correspondence to the respective blocks of the data, and the switching circuit operates during the course of reading one of the blocks of the data from the storage device for switching the paths according to one of the different switching patterns corresponding to said one block of the data to be read.

7. The electronic apparatus according to claim 6, further comprising a memory for memorizing the correspondence between the different switching patterns and the respective blocks of the data written into the storage device, and a pattern selector for selecting the corresponding one of the different switching patterns by referring to the memory such that the switching circuit can switch the paths according to the selected switching pattern.

8. The electronic apparatus according to claim 4, wherein the storage device stores the data representative of multimedia contents containing at least one of pictures and music.

9. A method of operating an electronic apparatus having a processor for processing data, a storage device for storing the data, a controller for controlling the storage device and a data bus, the method comprising the steps of:
storing the data in the storage device such that the data is arranged in a given order;
reading the data from the storage device to the processor through the controller and writing the data into the storage device from the processor through the controller during the course of the processing of the data by the processor;
connecting between the storage device and the controller for transferring of the data therebetween by the data bus comprised of a set of paths; and
disarranging the set of the paths between the controller and the storage device such that the order of the stored data is changed from the order of the processed data.

10. The method according to claim 9, wherein the storing step stores the data in the storage device such that the data is represented by a set of bits arranged in the given order, the connecting step connects between the storage device and the controller through the set of the paths for enabling parallel transferring of the set of the bits, and the disarranging step disarranges the set of the paths between the controller and the storage device such that the order of the bits of the stored set is changed from the order of the bits of the processed set.

11. A method of operating an electronic apparatus having a processor for processing data, a storage device for storing the data, a controller for controlling the storage device and a data bus, the method comprising the steps of:
storing the data in the storage device such that the data is arranged in a given order;
reading the data from the storage device to the processor through the controller and writing the data into the storage device from the processor through the controller during the course of the processing of the data by the processor;
connecting between the storage device and the controller for transferring of the data therebetween by means of the data bus comprised of a set of paths; and
switching the set of the paths in the middle of the data bus according to a given switching pattern such that the order of the data is altered between the data stored in the storage device and the data processed by the processor in correspondence to the switching pattern.

12. The method according to claim 11, wherein the storing step stores the data in the storage device such that the data is represented by a set of bits arranged in the given order, the connecting step connects between the storage device and the controller through the set of the paths for enabling parallel transferring of the set of the bits, and the switching step switches the set of the paths in the middle of the data bus according to a given switching pattern such that the order of the bits is altered between the set stored in the storage device and the set processed by the processor in correspondence to the switching pattern.
